(19) United States
(12) Patent Application Publication
(10) Pub. No.: US 2025/0045072 A1
(43) Pub. Date: Feb. 6, 2025

(54) AUTOMATED USER EXPERIENCE (UX) ANALYTICS FRAMEWORK

(71) Applicant: WORKDAY, INC., Pleasanton, CA (US)

(72) Inventors: Edwin SALOMONS, Dublin (IE); Niall HURLEY, Dublin (IE); James CURRAN, Dublin (IE); Cormac NOLAN, Dublin (IE); Darren REID, Dublin (IE); Emmett CAREY, Dublin (IE); Nathan DOWNEND, Pleasanton, CA (US); Suraj SINHA, Pleasanton, CA (US)

(21) Appl. No.: 18/365,163

(22) Filed: Aug. 3, 2023

(51) Int. Cl. G06F 9/451; G06F 9/445

(52) U.S. Cl. CPC G06F 9/451; G06F 9/44505

(57) ABSTRACT

In some implementations, the techniques described herein relate to a method including: detecting, by a processor, an interaction with an element of a user interface (UI); identifying, by the processor, a plurality of element properties responsive to the interaction, the plurality of element properties corresponding to the element and at least one ancestor element of the element; generating, by the processor, an identifier of the element based on the plurality of element properties; generating, by the processor, an exploration configuration file including the identifier; and transmitting, by the processor, the exploration configuration file to a processing platform.

### BACKGROUND

User experience analytics (UXA) systems for software applications generally capture data representing user interactions with such applications. Designers of software applications can then adjust the software applications (e.g., business logic, presentation layer, etc.) after analyzing the captured data.

### BRIEF DESCRIPTION OF THE DRAWINGS

FIG. 1 is a block diagram illustrating representations of a user interface (UI) according to some of the example embodiments.

FIG. 2 is a block diagram of a system for capturing and analyzing UX data according to some of the example embodiments.

FIG. 3 is a flow diagram illustrating a method for performing a UX exploration according to some of the example embodiments.

FIG. 4 is a flow diagram illustrating a method for building an exploration configuration file according to some of the example embodiments.

FIG. 5 is a flow diagram illustrating a method for generating a UI element hash according to some of the example embodiments.

FIG. 6 is a diagram illustrating the construction of an example UI element hash according to some of the example embodiments.

FIG. 7 is a diagram illustrating a sampling process for generating a UX analytics dataset according to some of the example embodiments.

FIG. 8 is a block diagram of a computing device according to some embodiments of the disclosure.

### DETAILED DESCRIPTION

Typical UXA systems employ a workflow that requires significant technical knowledge. Generally, a product expert defines the interactions with a software application that must be tracked by a UXA system. Next, a software development team (or dedicated analytics team) modifies portions of the software application to capture the defined interactions (e.g., click or tap events captured via event handlers). Next, a DevOps (or similar team) deploys the modified software application to a production environment such that end users can interact with the modified software application. End users then interact with the modified software application and the software application captures the defined interactions. The modified software application can report these captured interactions to a remote analytics server for storage and, ultimately, processing. Finally, as an example, a designer of the software application (e.g., product manager, software engineer, etc.) can review the captured interactions and make decisions on how to adjust the software application.

As illustrated in the preceding example workflow, current UXA systems rely on multiple specialized individuals or teams to operate (e.g., product experts, software engineers or analytics engineers, DevOps teams, etc.). As a result, current UXA systems require long lead times to run user experience (UX) explorations. Further, such UXA systems are necessarily brittle, requiring changes to source code specific to a single interaction type. Finally, such UXA systems can require significant amounts of time, as interactions are captured, before meaningful analytics can be generated. The example embodiments solve these and other technical problems in the art of UXA systems.

The example embodiments solve these and other shortcomings in the state of UXA systems by providing a lightweight UI extension that allows end-users to select UI elements while viewing a page, obviating the need for low-level code analysis and modification. Each selected UI element is converted into an array of hashes (or similar techniques to uniquely identify a given UI element) that incorporates both UI properties of the selected elements and all of its ancestor UI elements in a view hierarchy. A backend process can then use these hashes to uniquely and consistently identify a UI element and optionally sample a warehouse of interactions to rapidly visualize the interactions with the UI element. In some implementations, any function that can generate a unique identifier for a UI element that is able to match the UI element even if underlying application data changes (e.g., text strings within the text content of a UI element). This sampling can converge on an optimal sampling rate over time to provide a balanced tradeoff between rapid results and more accurate visualizations.

In some implementations, the techniques described herein relate to a method including: detecting, by a processor, an interaction with an element of a user interface (UI); identifying, by the processor, a plurality of element properties responsive to the interaction, the plurality of element properties corresponding to the element and at least one ancestor element of the element; generating, by the processor, an identifier of the element based on the plurality of element properties; generating, by the processor, an exploration configuration file including the identifier; and transmitting, by the processor, the exploration configuration file to a processing platform.

In some implementations, the techniques described herein relate to a method, wherein detecting the interaction includes detecting one or more of a click or tap event via an event handler.

In some implementations, the techniques described herein relate to a method, wherein identifying the plurality of element properties includes identifying one or more Hypertext Markup Language (HTML) attributes of the element and the at least one ancestor element.

In some implementations, the techniques described herein relate to a method, wherein generating the identifier of the element includes hashing each of the plurality of element properties to generate hash values corresponding to the element and the at least one ancestor element.

In some implementations, the techniques described herein relate to a method, wherein generating the identifier of the element includes combining the hash values to form the identifier of the element.

In some implementations, the techniques described herein relate to a method, wherein generating the exploration configuration file further includes receiving event properties defining at least one event type associated with the element.

In some implementations, the techniques described herein relate to a method, further including sampling, by the processing platform, interaction data associated with the element and generating, by an analytics platform, a visualization of the interaction data.

In some implementations, the techniques described herein relate to a non-transitory computer-readable storage medium for tangibly storing computer program instructions capable of being executed by a computer processor, the computer program instructions defining steps of: detecting an interaction with an element of a user interface (UI); identifying a plurality of element properties responsive to the interaction, the plurality of element properties corresponding to the element and at least one ancestor element of the element; generating an identifier of the element based on the plurality of element properties; generating an exploration configuration file including the identifier; and transmitting the exploration configuration file to a processing platform.

In some implementations, the techniques described herein relate to a non-transitory computer-readable storage medium, wherein detecting the interaction includes detecting one or more of a click or tap event via an event handler.

In some implementations, the techniques described herein relate to a non-transitory computer-readable storage medium, wherein identifying the plurality of element properties includes identifying one or more Hypertext Markup Language (HTML) attributes of the element and the at least one ancestor element.

In some implementations, the techniques described herein relate to a non-transitory computer-readable storage medium, wherein generating the identifier of the element includes hashing each of the plurality of element properties to generate hash values corresponding to the element and the at least one ancestor element.

In some implementations, the techniques described herein relate to a non-transitory computer-readable storage medium, wherein generating the identifier of the element includes combining the hash values to form the identifier of the element.

In some implementations, the techniques described herein relate to a non-transitory computer-readable storage medium, wherein generating the exploration configuration file further includes receiving event properties defining at least one event type associated with the element.

In some implementations, the techniques described herein relate to a non-transitory computer-readable storage medium, further including sampling, by the processing platform, interaction data associated with the element and generating, by an analytics platform, a visualization of the interaction data.

In some implementations, the techniques described herein relate to a device including: a processor; and a storage medium for tangibly storing thereon logic for execution by the processor, the logic including instructions for: detecting, by the processor, an interaction with an element of a user interface (UI); identifying, by the processor, a plurality of element properties responsive to the interaction, the plurality of element properties corresponding to the element and at least one ancestor element of the element; generating, by the processor, an identifier of the element based on the plurality of element properties; generating, by the processor, an exploration configuration file including the identifier; and transmitting, by the processor, the exploration configuration file to a processing platform.

In some implementations, the techniques described herein relate to a device, wherein detecting the interaction includes detecting one or more of a click or tap event via an event handler.

In some implementations, the techniques described herein relate to a device, wherein identifying the plurality of element properties includes identifying one or more Hypertext Markup Language (HTML) attributes of the element and the at least one ancestor element.

In some implementations, the techniques described herein relate to a device, wherein generating the identifier of the element includes hashing each of the plurality of element properties to generate hash values corresponding to the element and the at least one ancestor element.

In some implementations, the techniques described herein relate to a device, wherein generating the identifier of the element includes combining the hash values to form the identifier of the element.

In some implementations, the techniques described herein relate to a device, wherein generating the exploration configuration file further includes receiving event properties defining at least one event type associated with the element.

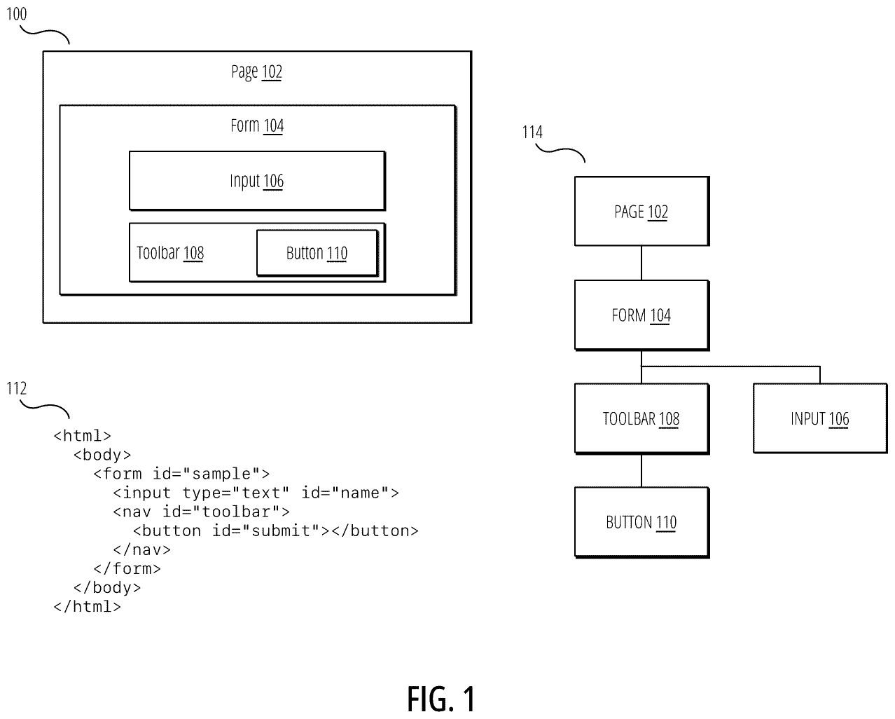

FIG. 1 is a block diagram illustrating representations of a user interface (UI) according to some of the example embodiments.

In the illustrated example, a UI is depicted in various forms. A graphical representation 100 (or “view”) illustrates the visible representation of the UI (e.g., closely resembling that which is rendered on screen). The graphical representation 100 includes various sub-components (or “sub-views”) that form the visible depiction of the UI including, as non-limiting examples, a page component 102, form component 104, input component 106, toolbar component 108, and button component 110. Some of all of these components may include visible portions as well as non-visible portions. For example, page component 102 may act as a “container” for visible components (e.g., input component 106 or button component 110) but may not, itself, have any visible characteristics. In the illustrated example, components can be nested within one another, forming a hierarchy of views. Each component may be associated with code or other data structures representing its display as well as code for handling interactions detected from a user viewing the UI (as well as code for performing programmatic functions).

The UI depicted in FIG. 1 can be implemented in numerous languages and deployed on different devices. One example of such a language is Hypertext Markup Language (HTML). An HTML representation 112 of graphical representation 100 is depicted in FIG. 1. Similar to the nested view of graphical representation 100, the HTML representation 112 presents sub-components in a hierarchal manner. The various HTML tags in HTML representation 112 correspond to the components of graphical representation 100. For example, the HTML FORM tag may correspond to form component 104, the NAV tag may correspond to toolbar component 108, the BUTTON tag may correspond to button component 110, and the INPUT tag may correspond to input component 106. In some implementations, the correspondence may not be 1:1; for example, the HTML and BODY tags may be considered the page component 102 (alternatively, only the BODY tag may be considered page component 102).

Although, HTML is illustrated, other languages may be used. For example, extensible Markup Language (XML) may be used as an agnostic choice of representing a UI. Further, other languages or dialects such as JSX (used in React and React Native), SwiftUI for iOS®, Compose for Android®, or any similar type of language can be used. Indeed, as illustrated, any technique capable of generating hierarchal UIs may be used as illustrated by hierarchy 114. In the hierarchy 114, each view component is connected to a single parent view and zero or more child views, resulting in a tree structure. In hierarchy 114, the page component 102 represents the root of the hierarchy 114 while button component 110 and input component 106 represent the leaf nodes of the hierarchy 114. As such, any technique for building a UI that results in a tree such as that illustrated by hierarchy 114 may be used.

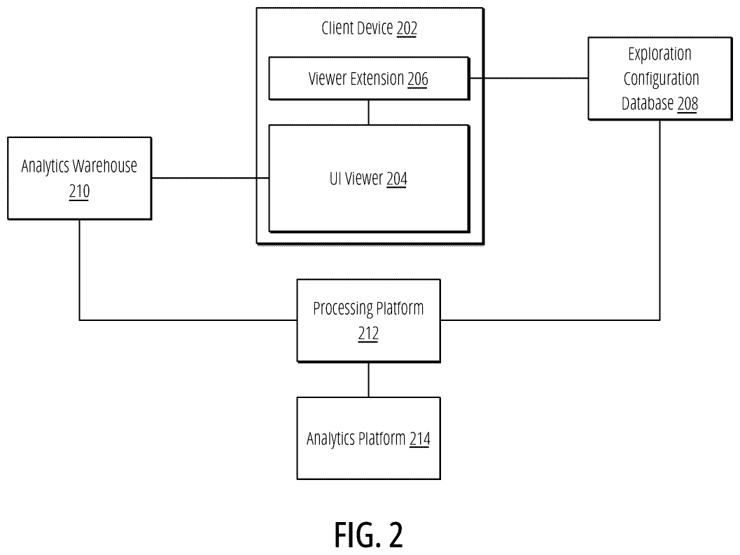

FIG. 2 is a block diagram of a system for capturing and analyzing UX data according to some of the example embodiments.

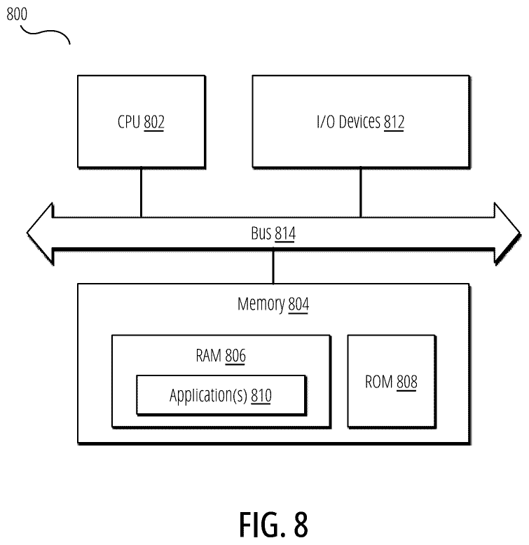

In the illustrated example, the system includes a client device 202. Client device 202 can comprise a general purpose computing device (e.g., laptop, desktop, mobile device, etc.) such as that depicted in FIG. 8. The specific components of client device 202 are not intended to be limiting. Client device 202 includes a UI viewer 204 and a viewer extension 206. UI viewer 204 can comprise executable code for displaying a UI. As non-limiting examples, UI viewer 204 can be a web browser, embedded web view, mobile application, desktop application, etc. In general, a web browser will be used in the following description, however the disclosure is not limited only to web browsers. In some implementations, client device 202 can request user interfaces from a remote server (not illustrated) to display in UI viewer 204. For example, UI viewer 204 can issue requests using a protocol such as Hypertext Transfer Protocol (HTTP) for web pages which include UIs. The UI viewer 204 can receive these web pages and render the UIs in UI viewer 204. The UIs can include presentational content (e.g., HTML) as well as scripts or applications (e.g., JavaScript code) to provide interactivity and other programmatic functions. In some implementations, as will be discussed, these scripts can monitor user interactions with the UI and transmit data to analytics warehouse 210.

As illustrated, UI viewer 204 includes viewer extension 206. In some implementations, the viewer extension 206 can comprise an add-on or other type of helper application to manage UX explorations. As one non-limiting example, viewer extension 206 can comprise a browser extension installed within a web browser. As another non-limiting example, viewer extension 206 can comprise application code included in the transmitted UI (e.g., JavaScript code included in the received webpage).

In some implementations, viewer extension 206 can access UIs displayed in UI viewer 204. In some implementations, viewer extension 206 can display modal dialogs or other displays that allow users to define a UX exploration. In some implementations, viewer extension 206 can also include code that allows users to select UI elements within a UI. In some implementations, this selection can be made directly on the UI. Specifically, after enabling a UI selection mode (for example), the user can use an input device (e.g., mouse, keyboard, touchscreen, etc.) to select a UI element. Viewer extension 206 can be configured to receive the UI element after the selection and compute a hash for the UI element. Viewer extension 206 can further be configured to store this hash and other data of the UI element in an exploration configuration. In some implementations, viewer extension 206 can transmit the exploration configuration to exploration configuration database 208. Details of these operations are provided further with respect to the flow diagrams and are not repeated herein.

In some implementations, the viewer extension 206 can further be configured to detect and remedy hash collisions. For example, if multiple UI elements in the same container are selected, there is a potential risk that the hashes generated for each of the multiple UI elements are the same. In this scenario, the viewer extension 206 can notify or alert the user of the collision and fail (i.e., not continue processing the selected UI elements). Alternatively, or in conjunction with the foregoing, the viewer extension 206 can select a parent UI element for some or all of the colliding UI elements and notify the user that a parent UI element was used in lieu of the selected UI element. Alternatively, or in conjunction with the foregoing, the viewer extension 206 can proactively identify colliding UI elements and prevent selection of such UI elements.

Concurrently with the aforementioned operations, UI viewer 204 can be configured to record interactions of users with the UI. In some implementations, the recording of these interactions can be performed independent of the operations of viewer extension 206. For example, a UI transmitted to, and displayed by, UI viewer 204 can include application code for detecting user interactions and, in response, transmitting data representing these interactions to analytics warehouse 210. For example, UI viewer 204 can setup event handlers to detect all potential user interactions (e.g., clicks, scrolls, hovers, taps, etc.) and upon detecting these interactions can transmit the event type, UI element identifier or hash, time, and other data to analytics warehouse 210 for storage.

In some implementations, analytics warehouse 210 can comprise a data warehouse, data lake, or other big data storage device. In some implementations, analytics warehouse 210 can comprise a service providing big data storage. Processes for collecting user interaction data from a UI and storing such data in a warehouse or similar storage device are not limiting and any approach may be used for bulk collection of such data. Generally, any storage technique that allows for large-scale storage of event data and later ad hoc retrieval of such data may be used.

By contrast, exploration configuration database 208 may comprise a data store that stores exploration configuration data generated by viewer extension 206. As discussed, the viewer extension 206 can obtain metadata regarding an exploration (e.g., name, time range, etc.) as well as hashes or other identifiers of UI elements to include in the exploration. In some implementations, viewer extension 206 can serialize this data into an exploration configuration file, such as a JavaScript Object Notation (JSON) file and transmit the serialized data to exploration configuration database 208. In some implementations, exploration configuration database 208can comprise a lightweight database such as a key-value store, object store, etc. that stores exploration configurations. In some implementations, exploration configuration database 208can manage such configurations from a user- or account-level perspective (e.g., authenticating users, assigning user or account identifiers to incoming configuration files, etc.).

The illustrated system further includes a processing platform 212. In some implementations, processing platform 212 can comprise a cloud-based platform for processing analytics data. As illustrated, processing platform 212 is communicatively coupled to exploration configuration database 208 and analytics warehouse 210. Operational and functional details of processing platform 212 are described more fully in the following flow diagrams. However, at a high-level, processing platform 212 can access a given exploration configuration from exploration configuration database 208 and identify UI element hashes in the given exploration configuration. Processing platform 212 can then generate a query to analytics warehouse 210 which identifies only those interactions with UI elements in the UI element hashes (e.g., any UI element in a hash array of a given UI element). In some implementations, the processing platform 212 can further refine this query by requesting only a subset of all collected events based on a sampling rate. Processing platform 212 can then forward the received interactions to an analytics platform 214. In some implementations, processing platform 212 can further provide status updates to a client device 202 regarding the status of analytics processing.

Analytics platform 214 can comprise a cloud-based platform for visualizing analytics data. In some implementations, analytics platform 214 can be configured to receive raw event (e.g., interaction) data from a data source (e.g., processing platform 212) and perform aggregated analysis of this raw data. For example, analytics platform 214 can provide segment-based analysis or category-based analysis of raw data. In some implementations, analytics platform 214 can allow for custom analytics views of raw data, allowing users to define visualizations based on the underlying raw data.

Specific operations of the foregoing components are described in connection with the following flow diagrams.

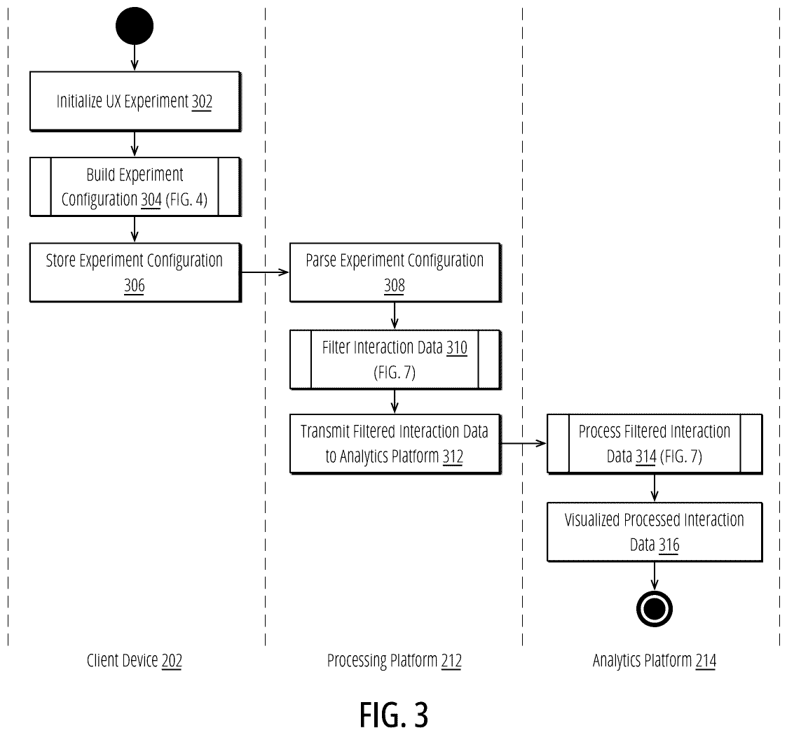

FIG. 3 is a flow diagram illustrating a method for performing a UX exploration according to some of the example embodiments.

In step 302, the method can include initializing a UX exploration.

In some implementations, a user can initialize a UX exploration by utilizing a UI viewer (e.g., a web browser) equipped with a viewer extension. Details of these components are provided in the description of FIG. 2 and are not repeated herein. In some implementations, a user can navigate to a UI (e.g., web page) and load the UI in the UI viewer. In some implementations, the user can initialize a UX exploration by interacting with the viewer extension. For example, if the viewer extension includes a toolbar icon or similar element, the user can select the icon and initialize the UX exploration. In some implementations, the viewer extension can initialize an empty exploration configuration. In some implementations, the viewer extension can pre-populate some details of the UX exploration. Alternatively, or in conjunction with the foregoing, the viewer extension can also record user interactions with a user interface and identify all interactions performed during the recording and the corresponding UI elements. For example, the viewer extension can populate the exploration configuration with a uniform resource locator (URL) of the current web page, a title of the current web page, user details (e.g., user ID, etc.) of the user, and various similar properties. In some implementations, some of these properties (e.g., URL, title) can be identified by parsing the source code of the web page. In some implementations, the viewer extension can further prompt a user for metadata or similar types of data regarding the UX exploration.

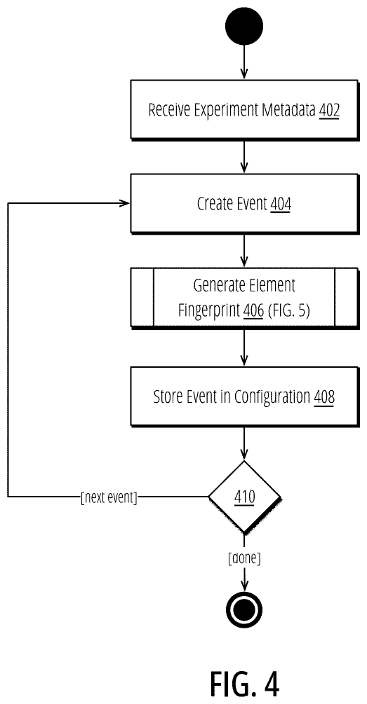

In step 304, the method can include building the exploration configuration. In some implementations, building the exploration configuration can include populating the exploration configuration file with metadata supplied by the user. In some implementations, building the exploration configuration can include receiving a selection of UI elements on the currently displayed UI for inclusion in the exploration. In some implementations, building the exploration configuration can include receiving properties of the UI elements to define the exploration for each element. Specific details of step 304 are described more fully in FIG. 4 which is not repeated herein.

In step 306, the method can include storing the exploration configuration.

In some implementations, the viewer extension can transiently store the exploration configuration in memory of the client device executing the viewer extension. In some implementations, step 306 can also include persisting the exploration configuration to a long-term storage device. In some implementations, step 306 can include writing the exploration configuration to a local disk of the client device executing the viewer extension. In other implementations, discussed more herein, the viewer extension can also transmit the exploration configuration to a remote computing device. In some implementations, the viewer extension can transmit the exploration configuration to a database such as exploration configuration database 208 described in FIG. 2. In some implementations, the exploration configuration can be stored both locally and remotely. In these implementations, the viewer extension can optionally be configured to receive updates regarding the exploration configuration from a remote source. For example, processing platform 212 can transmit updates regarding the status of processing of analytic events to the viewer extension. In these implementations, each exploration configuration can be associated with unique ID and thus the viewer extension can update the exploration configuration to include the current status of the analytics processing. In this manner, the viewer extension can include a view that allows a user to not only create new exploration configurations but also see the status of any given exploration configuration created by the user (or by an account the user is authorized to access). In some implementations, the exploration configuration can be stored as a serialized file such as a JSON, extensible Markup Language (XML), YAML Ain′t Markup Language (YAML), or Tom's Obvious Minimal Language (TOML) document.

In step 308, the method can include parsing an exploration configuration. As illustrated, step 308 can be executed by processing platform 212.

In some implementations, processing platform 212 can be configured to monitor the exploration configuration database 208 and detect new exploration configurations uploaded to exploration configuration database 208. In other implementations, exploration configuration database 208can be equipped with a hook or other code that proactively forwards an exploration configuration to processing platform 212. In yet other implementations, processing platform 212 can be configured to periodically poll exploration configuration database 208 to identify new exploration configurations stored by exploration configuration database 208.

In any scenario, processing platform 212 receives a given exploration configuration and parses the underlying file (e.g., JSON, XML, YAML, TOML, etc.). As a result, processing platform 212 obtains the metadata and element-properties combinations included in the file. In response, processing platform 212 may create a new UX exploration in a database of UX explorations. In some implementations, processing platform 212 can use the metadata to initialize the database record for the UX explorations and generally store (and convert as necessary) the fields of the exploration configuration in the database for long-term storage. After initializing the details of the UX exploration, processing platform 212 next retrieves and/or monitors for interaction data recorded in a data warehouse. In some implementations, these interactions can be click, tap, or similar type of events. In some implementations, the events can be captured via event handlers present in the UI. As will be discussed next, processing platform 212 retrieves the interaction data based on the elements identified in the exploration configuration.

In step 310, the method can include filtering interaction data.

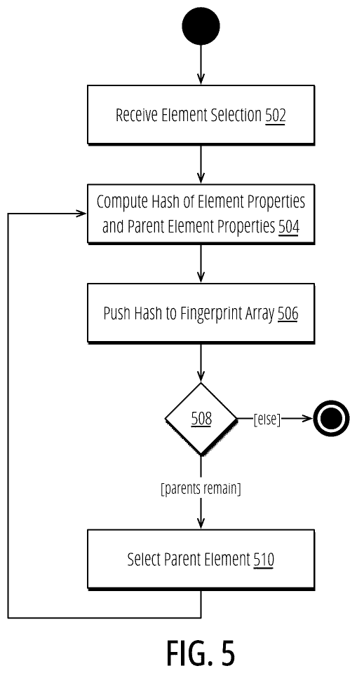

As discussed in FIG. 2, a data warehouse (e.g., analytics warehouse 210) can store data regarding all interactions for any given webpage or UI managed by the example embodiments. Such data may be significant as all interactions are captured. In some implementations, each of these interactions can be associated with an array of hashes of the UI element and its ancestors that the user interacts with. In step 310, the method selects a full or partial hash of the UI elements, the full hash stored within the exploration configuration and selects some of all interactions stored in the data warehouse that match the hash. In some implementations, the method can iteratively attempt to retrieve interaction data using multiple hashes for a single element. As will be described in FIGS. 4 and 5, each UI element can be associated with multiple hashes: one hash for the UI element itself and zero or more hashes for its ancestor UI elements. By expanding the hash, the method can (as an example) remove the top-most ancestor hash and re-execute the query. If no (or too few) results are returned, the method can remove the second top-most ancestor, etc. Ultimately, the method can continue like this until only the UI element hash is used.

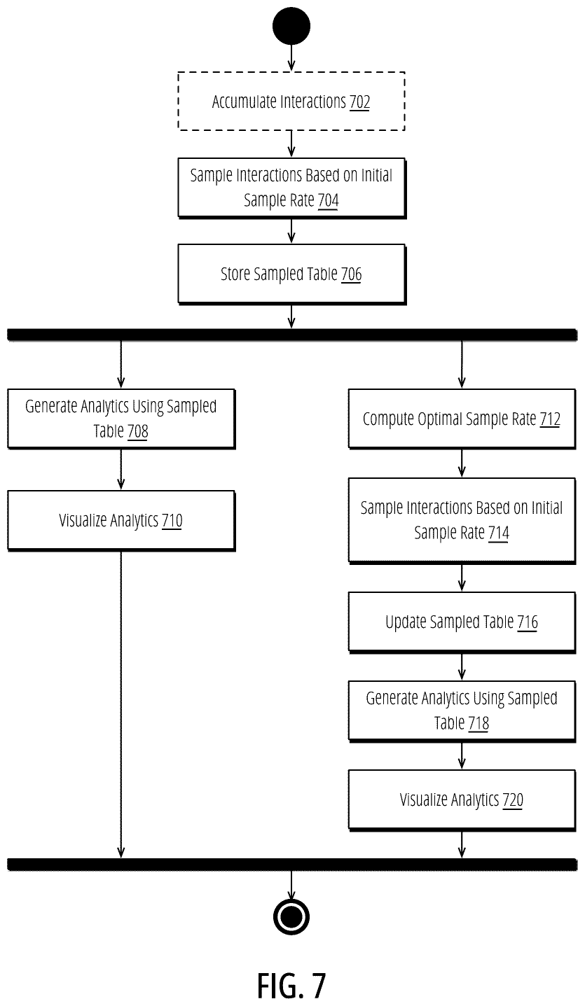

In some implementations, the method can include further applying a temporal filter that limits the interaction data to a specified time window. In some implementations, this time window can be specified in the exploration configuration itself. In some implementations, the method can further include sampling the interaction data stored in the data warehouse and then adjusting this sampling based on a tunable sample rate, as will be described in more detail in FIG. 7. As discussed, the above sampling of a UI element can be repeated for all UI elements included in the exploration configuration.

In step 312, the method can include transmitting the filtered interaction data to an analytics platform. In some implementations, the method can aggregate the filter interaction data and transmit the entire data set in one transmission to the analytics platform. In other implementations, the method can stream the filtered interaction data as it is received from the data warehouse. In some implementations, the processing platform 212 can also include an identifier of the UX exploration to the analytics platform to synchronize the processed interaction data and any visualizations.

In step 314, the method can include processing the filtered interaction data. In some implementations, the filtered interaction data can be processed by an analytics platform. In some implementations, the processing can include generating aggregated statistics based on the filtered interaction data. In some implementations, the processing can also include generating reports, dashboards, or other representations of the data based on the filtered interaction data. In some implementations, after generating such a representation (or otherwise completing the processing) the analytics platform can notify the processing platform 212 which can, in turn, notify the client device 202 (and viewer extension). As discussed, the viewer extension can then display the status of the processing.

In step 316, the method can include visualizing the processed interaction data.

In some implementations, the representations of the filtered interaction data can be converted by the analytics platform into one or more visualizations. In some implementations, these visualizations can be graphs, charts, or other type of representations of the filtered interaction data. For example, one visualization may be a number of interactions per hour for a given UI element. Certainly, other visualizations are possible. In some implementations, the method can visualize the data in response to a user request. For example, a user may visit the analytics platform and request a visualization for a given UX exploration. In some implementations, the analytics platform can transmit the visualization to the user (e.g., via the viewer extension).

FIG. 4 is a flow diagram illustrating a method for building an exploration configuration file according to some of the example embodiments.

In step 402, the method can include receiving exploration metadata. In some implementations, exploration metadata can include metadata automatically extracted from a UI. For example, if the UI is a web page, the viewer extension can extract the URL and/or title from the web page upon initializing an exploration configuration. In conjunction with the foregoing, the viewer extension can prompt the user for additional metadata. For example, the viewer extension can prompt the user for an exploration name, start date, end date, etc.

In step 404, the method can include creating a new event.

As used herein, an event refers to a UI element and an action taken thereon. In some implementations, the viewer extension may allow a user to define any number of events. In some implementations, each event can include and event name, an interaction type (e.g., system eevent (e.g., page load, impression, popup), click, tap, confirm, etc.) as well as an identifier of a UI element (discussed next). In general, any type of interaction that can be detected via event handlers or similar code may be used. Further, no limitation is placed on the naming of a given event. In some implementations, the viewer extension can include a control that enables a selection mode. While in selection mode, an event handler can be added to the UI that detects any click or tap action on the UI. In response, the event handler is called with the UI element selected. In response, the event handler can execute step 406.

In step 406, the method generates a fingerprint for the UI element selected in step 404. Specific details of this process are described more fully in FIG. 5. In brief, the element generates a hash of some or all properties of the selected UI element and all ancestor UI elements up to a root element. The method then iteratively generates hashes in the same or similar manner for each ancestor of the UI element until a top-level or root ancestor is reached. In some implementations, this hash can be formed by using some of all of the attributes of the UI element. For example, if the UI is an HTML UI, the method can use a predefined list of attributes for each element to generate the hash. For example, an “id” attribute, “name” attribute, “class” attribute etc. can be concatenated and used as a hash input. In some implementations, the attribute and corresponding value can be used as the input (e.g., “id=‘toolbar’”) while in others only the attribute may be used. The specific hash function used is not limiting and any suitable function that can generate low-collision probability hashes can be used (e.g., MD5, SHA-256, etc.). In some implementations, the hash function can be selected based on a size of the hash value generated. In some implementations, the entire hash function output for each element may be used. However, in other embodiments, a subset of the entire hash function (e.g., a fixed length prefix or suffix) may be used. In some implementations, the fingerprint can comprise an array of hash values. In other implementations, the array values can be concatenated to form a single fingerprint.

In some implementations, step 404 can be executed after step 406. Indeed, when defining a single exploration some events can be added by performing step 404 and then step 406 while others can be added by performing step 406 then step 404.

In some implementations, when step 406 is performed first, the method can dynamically adjust the possible event types. Specifically, the user may be able to select any UI element in the UI. Some UI elements may be associated with certain types of events while others are associated with other events. For example, a button or link UI element may respond to click or tap events. In some implementations, the UI element may also respond to system events such as impressions (displays), pop ups, etc. However, an HTML form element may not respond to such events but may respond to “submit” events. Thus, in some implementations, the method can determine a type of the selected UI element and pre-populate a list of available event types in response. It should further be noted generally that an interaction need not be caused specifically by “selection” type user input and any type of event can be used. In the context of HTML, for example, focus, scroll, idle, document object model (DOM) mutation, and any other type of event type can be used.

In step 408, the method can include storing the event in the exploration configuration. In some implementations, the exploration configuration can be stored in memory as a dictionary or other data structure and each event can be added to an array of exploration events. Correspondingly, each event can be represented as its own dictionary of keys and values.

In step 410, the method can include determining if another event should be created. As discussed, the viewer extension may allow a user to add any number of events to the exploration. As such, the viewer extension may await a user's request to add another event to the exploration. In response, the method can re-execute step 404, step 406, and step 408 for each event that the user wishes to add. Once the user finishes adding events, the user may select a finish or submit button to end the exploration creation process.

FIG. 5 is a flow diagram illustrating a method for generating a UI element hash according to some of the example embodiments.

In step 502, the method can include receiving the selection of a UI element.

As discussed in FIG. 4, a viewer extension can prompt the user to select an element in the UI (the UI element). In some implementations, the viewer extension can (temporarily or permanently) attach an event handler to the UI that can detect which element a user selects. In some implementations, the viewer extension can darken or otherwise partially obscure all elements of the page other than the selected UI element to aid the users understand of which UI element was selected. If the event handler is temporary, it may be removed after the method of FIG. 5 completes. Using HTML as an example, the viewer extension can attach an event handler function to the BODY element of the HTML page such as:

```
const body = document.querySelector(‘body’);
body.addEventListener(‘click’, function(event) {
  const clickedElement = event.target;
  hash(clickedElement);
});
```

Here, the hash function comprises a function to generate a hash of the clickedElement object, discussed next. In some implementations, this hash function can include a line to remove the event handler or listener after executing.

In step 504, the method can include computing a hash of the selected UI elements properties or attributes as well as all parent UI elements' properties or attributes.

Various techniques can be used to select properties or attributes of a UI element to use for hashing. In a first example, using HTML as an example, the opening tag of the selected UI element can be used as the input. For example, the opening tag of a given HTML can be selected by accessing and processing the outerHTML property of the element: element.outerHTML.split(‘>’)[0]+‘>’.

As another example, a subset of the attributes or properties of the UI element can be used to generate a hash input. For example, the method can select a list of pre-identified attribute names and use these as inputs to a hash function. Alternatively, or in conjunction with the foregoing, the method can read properties of the UI element and uses these as inputs to the hash function. For example, the method can use a tag name (“BUTTON”), an id (“submit”), and a class name (“btn primary”) as fields to hash and construct a hash input as “button #submit.btn.primary”). Certainly, other fields and combinations there of can be used.

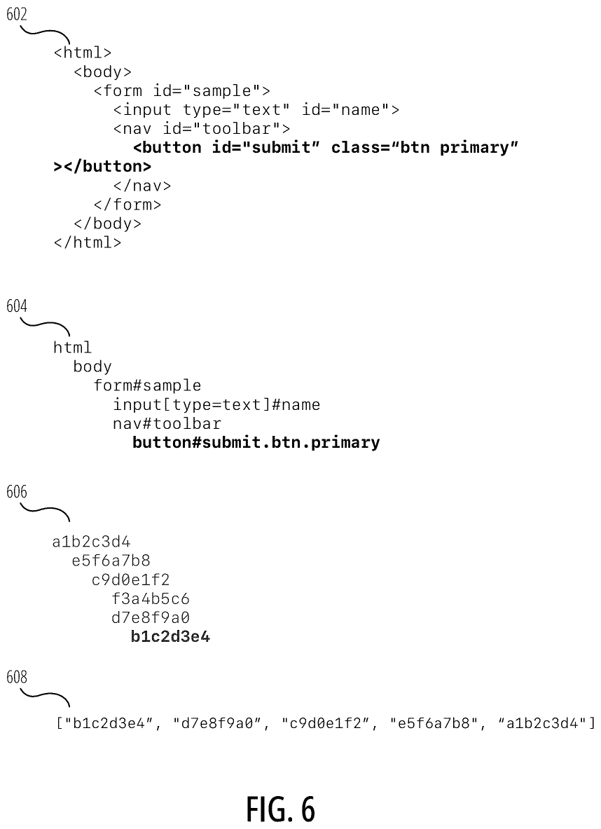

FIG. 6 graphically illustrates the foregoing non-limiting example. As illustrated, the BUTTON element is selected in code 602 via step 502. Code 602 may be represented as a tree of hashable values in code 604. Specifically, in code 604, the tag name and type, id, and class attributes of each element are extracted and used to build hashable strings representing each node. Although code 604 illustrates all elements being converted at once, in some implementations, each element can be converted as it is processed according to the loop of FIG. 5. Next, in tree 606, each element and its parents can be hashed. In some implementations, an MD5, SHA-256 of similar type of computer-implemented hash function can be used. As illustrated, in some implementations, the hash can be truncated based on a prefix or suffix length (e.g., eight bytes in the illustrated example).

In some implementations, the hash is optimized such that it has an extremely high likelihood of it matching against a specific element and a high resiliency against it being unaffected by irrelevant changes in the product implementation, i.e., unrelated HTML tags or application data being added or removed. Such an optimization can be performed by selecting specific attributes or properties of the element and using a sufficiently strong hash function.

In some implementations, the hash computed in step 504 includes not only the current UI element being analyzed but all parent UI elements in the view hierarchy. Returning to FIG. 6, when the method is processing the BUTTON element, the method may hash the attributes or properties of not only the BUTTON element, but also the NAV, FORM, BODY, and HTML elements. Further, when the method moves up the hierarchy and is processing the NAV element, it will compute a hash based on the NAV, FORM, BODY, and HTML elements. In this manner, the method would compute the following hashes for the example of FIG. 6:

hash(<button...><nav...><form...><body...><html...>) = b1c2d3e4
hash(<nav...><form...><body...><html...>) = d7e8f9a0
hash(<form...><body...><html...>) = c9d0e1f2
hash(<body...><html...>) = e5f6a7b8
hash(<html...>) = a1b2c3d4

Here, the convention of ELEMENT . . . represents the selected attributes or properties of ELEMENT, as discussed.

In step 506, the method can include pushing the hash to a fingerprint array. In some implementations, the method can maintain an array that is initialized as empty and is populated with hash values as the method traverses the UI hierarchy. Other data structures may be used. As illustrated in FIG. 6, an array 608 can be built by pushing each generated hash for the selected UI element and its ancestors to this array. In some optional embodiments, the array can be combined or concatenated to form a single string. In other implementations, the array may not be combined and may be serialized and transmitted as the list of hashes.

In step 508, the method can include determining if any ancestor UI elements exist. If not, the method ends. If at least one ancestor UI element exists, the method proceeds to step 510.

In some implementations, step 508 may be implemented by programmatically querying the currently selected UI element and requesting its parent ancestor. For example, if the UI is an HTML UI, the method can read the parentElement of parentNode property of the JavaScript DOM representation of the UI element. These properties will return either null (if no ancestors remain) or the parent of the current UI element.

In step 510, the method selects the ancestor UI element. In some implementations, step 504 through step 510 can be implemented as the body of a loop. In step 510, the final step of the loop body can be to update the reference to the current UI element. For example, the method can assign the parentElement or parentNode property of the JavaScript DOM representation of the current UI element as the new current UI element and return to step 504.

FIG. 7 is a diagram illustrating a sampling process for generating a UX analytics dataset according to some of the example embodiments.

In step 702, the method can include accumulating interactions. As discussed in the previous description, a UI can include event handlers to monitor for user interactions with UI elements. In some implementations, these interactions can be transmitted to a data warehouse or other storage system for bulk storage. In some implementations, the UI can record all interactions of all users with a given UI. In some implementations, each interaction can be associated with a hash of the UI element (generated using the process of FIG. 5). Given the scope of capture, the total number of interactions for a given UI may be significantly large. In general, processing of all interactions for a given UI element may be significantly costly and thus the method of FIG. 7 employs an adjusting sampling technique to provide rapid results while optimizing based on the size of the interaction space. In some implementations, the method of FIG. 7 can be run for each UI element to visualize.

In step 704, the method can include sampling the accumulated interactions based on an initial sample rate.

In some implementations, the initial sample rate can define a percentage of the total relevant interactions to use for further processing. For example, an initial sample rate of 1:50000 (one interaction used for every 50,000 recorded interactions) may be used to reduce the sample set size. In some implementations, sampling can include sampling interaction by unique user identifier (the user interacting) and date combinations.

In step 706, the method can include storing a table including the sampled data temporarily for processing. In some implementations, the method can store the table in a lightweight database or other suitable structure that allows for reading and updating, as will be discussed.

After selecting the sampled interactions, the method can perform two tasks in parallel. In a first task (step 708 through step 710), the method can process the initial sampling. In a second task (step 712 through step 710), the method can refine the sample rate and visualize a new dataset. These two tasks are discussed next.

In step 708, the first task includes generating analytics using the initially sampled data. As described above, in some implementations, a processing platform can process the initially sampled data and format the initially sampled data in a format processible by an analytics platform. In some implementations, the processing platform can forward the initially sampled data to the analytics platform. In response, in step 710, the method can include the analytics platform visualizing the initially sampled data. In some implementations, the representations of the initially sampled data can be converted by the analytics platform into one or more visualizations. In some implementations, these visualizations can be graphs, charts, or other type of representations of the initially sampled data. For example, one visualization may be a number of interactions per hour for a given UI element. Certainly, other visualizations are possible. In some implementations, the method can visualize the initially sampled data in response to a user request. For example, a user may visit the analytics platform and request a visualization for a given UX exploration. In some implementations, the analytics platform can transmit the visualization to the user (e.g., via the viewer extension).

In step 712, the second task includes computing an optimal sample rate. As discussed, this second task can be executed while step 708 and step 710 are executing. Indeed, step 708 and step 710 may complete relatively quickly compared to the second task, thus allowing for rapid results while the system fine-tunes the sampling. In some implementations, the method can calculate the optimal sampling rate(S) based on the number of events returned in step 704. In some implementations, this can be done using a target number of events T and number of events from the initial run R (step 704) wherein a 1:C sampling rate was used as follows:

$$S = \frac{( R * C )}{T}$$

Thus, if 1,000 interactions were returned in step 702 at a rate of 1:50000 and a target number of events is 1,000,000, the optimal sample rate can be computed as 1:50. In some implementations, this sample rate can then be used directly. In other implementations, a set of samples rates can be selected from using the optimal rate. For example, the system may support sample rates of 1:50000, 1:2000, 1:100, and 1:1. Here, the method can include selecting the available sample rate that is closest but higher than the optimal sample rate. In the previous example, this would be a rate of 1:100.

In step 714, the method re-samples interactions using the optimal sample rate chosen in step 712. This can be done similar to or identical to that of step 704 and that description is not repeated herein.

Next, in step 716, the method updates the sampled table using the newly retrieved data. In some implementations, the method can simply overwrite the initial sample data stored in step 706. In other implementations, the method can add new, unique data to the initial sample data stored in step 706.

In step 718, the second task includes generating analytics using the optimal sampled data. As described above, in some implementations, a processing platform can process the optimal sampled data and format the optimal sampled data in a format processible by an analytics platform. In some implementations, the processing platform can forward the optimal sampled data to the analytics platform. In response, in step 720, the method can include the analytics platform visualizing the optimal sampled data. In some implementations, the representations of the optimal sampled data can be converted by the analytics platform into one or more visualizations. In some implementations, these visualizations can be graphs, charts, or other type of representations of the optimal sampled data. For example, one visualization may be a number of interactions per hour for a given UI element. Certainly, other visualizations are possible. In some implementations, the method can visualize the optimal sampled data in response to a user request. For example, a user may visit the analytics platform and request a visualization for a given UX exploration. In some implementations, the analytics platform can transmit the visualization to the user (e.g., via the viewer extension).

FIG. 8 is a block diagram of a computing device according to some embodiments of the disclosure.

As illustrated, the device 800 includes a processor or central processing unit (CPU) such as CPU 802 in communication with a memory 804 via a bus 814. The device also includes one or more input/output (I/O) or peripheral devices 812. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 802 may comprise a general-purpose CPU. The CPU 802 may comprise a single-core or multiple-core CPU. The CPU 802 may comprise a system-on-a-chip (SoC) or a similar embedded system. In some embodiments, a graphics processing unit (GPU) may be used in place of, or in combination with, a CPU 802. Memory 804 may comprise a memory system including a dynamic random-access memory (DRAM), static random-access memory (SRAM), Flash (e.g., NAND Flash), or combinations thereof. In one embodiment, the bus 814 may comprise a Peripheral Component Interconnect Express (PCIe) bus. In some embodiments, the bus 814 may comprise multiple busses instead of a single bus.

Memory 804 illustrates an example of a non-transitory computer storage media for the storage of information such as computer-readable instructions, data structures, program modules, or other data. Memory 804 can store a basic input/output system (BIOS) in read-only memory (ROM), such as ROM 808 for controlling the low-level operation of the device. The memory can also store an operating system in random-access memory (RAM) for controlling the operation of the device.

Applications 810 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 806 by CPU 802. CPU 802 may then read the software or data from RAM 806, process them, and store them in RAM 806 again.

The device may optionally communicate with a base station (not shown) or directly with another computing device. One or more network interfaces in peripheral devices 812 are sometimes referred to as a transceiver, transceiving device, or network interface card (NIC).

An audio interface in peripheral devices 812 produces and receives audio signals such as the sound of a human voice. For example, an audio interface may be coupled to a speaker and microphone (not shown) to enable telecommunication with others or generate an audio acknowledgment for some action. Displays in peripheral devices 812 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 812 may comprise any input device arranged to receive input from a user. An illuminator in peripheral devices 812 may provide a status indication or provide light. The device can also comprise an input/output interface in peripheral devices 812 for communication with external devices, using communication technologies, such as USB, infrared, Bluetooth®, or the like. A haptic interface in peripheral devices 812 provides tactile feedback to a user of the client device.

A GPS receiver in peripheral devices 812 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown in FIG. 8, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

1. A method comprising:
detecting, by a processor, an interaction with an element of a user interface (UI);
identifying, by the processor, a plurality of element properties responsive to the interaction, the plurality of element properties corresponding to the element and at least one ancestor element of the element;
generating, by the processor, an identifier of the element by hashing a combination of the plurality of element properties to form a unique fingerprint;
generating, by the processor, an exploration configuration file including the identifier and event properties defining at least one event type associated with the element; and
transmitting, by the processor, the exploration configuration file to a processing platform.

2. The method of claim 1, wherein detecting the interaction comprises detecting one or more of a click, tap event, or system event via an event handler.

3. The method of claim 1, wherein identifying the plurality of element properties includes identifying one or more Hypertext Markup Language (HTML) attributes of the element and the at least one ancestor element.

4. The method of claim 1, wherein generating the identifier of the element comprises hashing each of the plurality of element properties to generate hash values corresponding to the element and the at least one ancestor element.

5. The method of claim 4, wherein generating the identifier of the element comprises combining the hash values to form the identifier of the element.

6. The method of claim 1, wherein generating the exploration configuration file further includes receiving event properties defining at least one event type associated with the element.

7. The method of claim 1, further comprising sampling, by the processing platform, interaction data associated with the element and generating, by an analytics platform, a visualization of the interaction data.

8. A non-transitory computer-readable storage medium for tangibly storing computer program instructions capable of being executed by a computer processor, the computer program instructions defining steps of:
detecting an interaction with an element of a user interface (UI);
identifying a plurality of element properties responsive to the interaction, the plurality of element properties corresponding to the element and at least one ancestor element of the element;
generating an identifier of the element by hashing a combination of the plurality of element properties to form a unique fingerprint;
generating an exploration configuration file including the identifier and event properties defining at least one event type associated with the element; and
transmitting the exploration configuration file to a processing platform.

9. The non-transitory computer-readable storage medium of claim 8, wherein detecting the interaction comprises detecting one or more of a click, tap event, or system event via an event handler.

10. The non-transitory computer-readable storage medium of claim 8, wherein identifying the plurality of element properties includes identifying one or more Hypertext Markup Language (HTML) attributes of the element and the at least one ancestor element.

11. The non-transitory computer-readable storage medium of claim 8, wherein generating the identifier of the element comprises hashing each of the plurality of element properties to generate hash values corresponding to the element and the at least one ancestor element.

12. The non-transitory computer-readable storage medium of claim 11, wherein generating the identifier of the element comprises combining the hash values to form the identifier of the element.

13. The non-transitory computer-readable storage medium of claim 8, wherein generating the exploration configuration file further includes receiving event properties defining at least one event type associated with the element.

14. The non-transitory computer-readable storage medium of claim 8, further comprising sampling, by the processing platform, interaction data associated with the element and generating, by an analytics platform, a visualization of the interaction data.

15. A device comprising:
a processor; and
a storage medium for tangibly storing thereon logic for execution by the processor, the logic comprising instructions for:
detecting, by the processor, an interaction with an element of a user interface (UI);
identifying, by the processor, a plurality of element properties responsive to the interaction, the plurality of element properties corresponding to the element and at least one ancestor element of the element;
generating, by the processor, an identifier of the element by hashing a combination of the plurality of element properties to form a unique fingerprint;
generating, by the processor, an exploration configuration file including the identifier and event properties defining at least one event type associated with the element; and
transmitting, by the processor, the exploration configuration file to a processing platform.

16. The device of claim 15, wherein detecting the interaction comprises detecting one or more of a click, tap event, or system event via an event handler.

17. The device of claim 15, wherein identifying the plurality of element properties includes identifying one or more Hypertext Markup Language (HTML) attributes of the element and the at least one ancestor element.

18. The device of claim 15, wherein generating the identifier of the element comprises hashing each of the plurality of element properties to generate hash values corresponding to the element and the at least one ancestor element.

19. The device of claim 18, wherein generating the identifier of the element comprises combining the hash values to form the identifier of the element.

20. The device of claim 15, wherein generating the exploration configuration file further includes receiving event properties defining at least one event type associated with the element.
